(19) United States
(12) Patent Application Publication
(10) Pub. No.: US 2004/0050127 A1
(43) Pub. Date: Mar. 18, 2004

(54) Fertilizer based on elemental sulfur

(75) Inventor: Franco Ambri, Sassuolo (IT)

Correspondence Address: KUDIRKA & JOBSE, LLP, ONE STATE STREET, SUITE 800, BOSTON, MA, 02109, US

(73) Assignees: Franco Ambri, Sassuolo (IT); Giuseppe Macchioni, Santo Domingo (DO)

(21) Appl. No.: 10/660,940

(22) Filed: Sep. 12, 2003

(30) Foreign Application Priority Data
Sep. 17, 2002 (IT) M02002A000251

(51) Int. Cl. C05D 1/00

(52) U.S. Cl. 71/31

(57) ABSTRACT

The fertilizer based on elemental sulfur comprises elemental sulfur, at least one binder suitable to break down in the soil and selected from the group consisting of clays, bentonite, kaolins or the like or mixtures thereof, and at least one glassy-matrix preparation that contains at least one trace element selected from the group consisting of Fe, B, Zn, Cu, Co, Mn, Mo.

### FIELD OF THE INVENTION

The present invention relates to a fertilizer based on elemental sulfur.

The term “fertilizer” is used to designate any substance capable of increasing the yield of a soil and of providing the elements required for the growth of crops.

### BACKGROUND OF THE INVENTION

Fertilizers are divided into element fertilizers, amendments and correctives, while the elements that compose them are classified, depending on the quantity thereof required for the crops, into primary [nitrogen (N), phosphorus (P) and potassium (K)], secondary [calcium (Ca), magnesium (Mg), sodium (Na) and sulfur (S)] and trace elements [boron (B), cobalt (Co), copper (Cu), iron (Fe), manganese (Mn), molybdenum (Mo) and zinc (Zn)].

The main characteristics of a fertilizer include its titer, its solubility, on which its assimilability by plants depends, and speed of effect, i.e., how fast it is converted by the soil into forms that can be assimilated by plants.

Fertilizing elements include sulfur, whose main properties, which influence both its production and its use in the agricultural field, are insolubility in water, a melting point close to 113° C., easy flammability in air and irritating action for the human body.

Sulfur is used as an element fertilizer for feeding plants; it is in fact an essential component of certain vitamins and enzymes of plants and together with phosphorus and nitrogen takes part in the synthesis of certain plant proteins.

Sulfur is also used as an amendment, i.e., as a modifier of certain structural characteristics of the soil, including in particular its pH, which it shifts toward acid values.

Sulfur is naturally present in the soil as a component of certain salts, including for example sulfates and sulfides, or other complexes.

Moreover, various kinds of fertilizer containing sulfur are known and include fertilizers commonly referenced by the acronym NPK (based on nitrogen, phosphorus and potassium), which contain sulfur as salts, including for example ammonium sulfate, potassium sulfate and, in particular cases, sulfates of metallic trace elements such as for example Fe, Cu, Mn, Zn and Co.

Generally, simple or complex sulfates are soluble in water and are therefore easily washed out by irrigation water and rainwater.

To obviate this drawback, fertilizers have been used which are based on elemental sulfur, which is not subject to washing out because it is fully insoluble in water.

The sulfur, once introduced in the soil, is attacked by the microorganisms that are naturally present in said soil, including for example the thiobacterial flora, which convert it in situ into forms that are available to plants and can be assimilated by them.

If the soil has an alkaline pH, the sulfur made available by bacterial attack, generally in the form of sulfurous and/or hydrogen sulfide, helps to reduce the alkalinity of the soil, facilitating the absorption of metallic trace elements.

However, it is not possible to use elemental sulfur, in the form of fine powders, as such, for safety reasons linked to the fact that in this form it is extremely volatile, bums easily in air and is an irritant for the human body.

In order to avoid this drawback, fertilizers have long been known which are constituted by a mixture of elemental sulfur, a chemically inert agent acting as a dispersant, such as for example clay, bentonite, kaolins or the like, and optionally a wetting agent that facilitates fertilizer contact with the moisture contained in the soil and absorption thereof.

These fertilizers are produced by agglomeration as lens-shapes, ovules, cylinders, pellets or grains, with known methods for casting, wet extrusion or moist granulation of the mixture.

These fertilizers, after being spread into the soil, swell due to the absorption of moisture on the part of the clays (bentonite, kaolins or the like); a process of breakdown and dispersion thus begins which leads to the release of minute particles of elemental sulfur which, as described, are subject to the attack of bacterial microorganisms that convert them into sulfo-organic compounds that can be assimilated by plants.

An attempt has also been made to provide fertilizers that contain elemental sulfur and trace elements in order to provide the soil with both of these nutrients with a single application.

For example, it is known to use inorganic salts of the trace elements, which are added to the elemental sulfur by way of processes that entail wetting or absorption inside vacuoles formed on the surface of the molten sulfur or are mixed with the bath of molten sulfur.

These known fertilizers, based on elemental sulfur and trace elements, have drawbacks, including the fact that their production processes are difficult and complicated to industrialize and that their action on the soil is incomplete and uncontrolled.

It is noted, for example, that inorganic salts of trace elements, often used in their hydrated form, if added to the molten sulfur bath, are subject to modification and thermal breakdown due to the temperature (generally higher than 120° C.) to which said bath must be brought in order to achieve sufficient fluidity for treatment.

Moreover, the speed of effect of elemental sulfur and the speed of effect of inorganic salts of trace elements are considerably different from each other, the former being considerably lower than the latter, thus preventing a synergistic effect of the two kinds of nutrient added to the soil.

The aim of the present invention is to eliminate the drawbacks noted above of known fertilizers, by providing a fertilizer based on elemental sulfur that allows to add to the soil also trace elements that have unchanged agronomic properties, with an effect that is synergistic and can be modulated with respect to the effect of sulfur and can be obtained with methods that are easy to perform and industrialize.

### BRIEF DESCRIPTION OF THE INVENTION

In view of this aim and other objects that will become better apparent hereinafter, according to the present invention a fertilizer based on elemental sulfur is provided which comprises elemental sulfur, at least one binder suitable to break down in the soil, and at least one preparation having a glassy matrix which contains at least one trace element.

Moreover, the fertilizer according to the invention can comprise at least one wetting agent suitable to facilitate contact and absorption of moisture of the soil on the part of the binder.

### DETAILED DESCRIPTION OF THE INVENTION

The following examples are provided merely to illustrate the present invention and must not be understood as limiting its scope as defined by the appended claims.

In terms of the constitution of the fertilizer, the elemental sulfur is used in the form of the simple chemical element.

The binder performs several functions: during the production process of the fertilizer, it facilitates the aggregation of sulfur, of the glassy matrix preparations, and of any wetting agent, while during the use of the fertilizer it facilitates, by breaking down in the soil, the dispersion of the sulfur and of the glassy-matrix preparations.

The binder is chosen from the group that comprises clays, bentonites, kaolins and the like or mixtures thereof: the wetting agent is instead of the type of cationic or anionic organic surfactants.

Glassy-matrix preparations that add the trace elements are inorganic compounds obtained, according to known glassmaking techniques, by melting at temperatures on the order of 1000° C. mixtures of raw materials that contain, in addition to the components of the glassy matrix, at least one trace element selected from the group consisting of Fe, B, Zn, Cu, Co, Mn, Mo, and by subsequently rapidly cooling the molten material in order to obtain glassy particles.

To obtain the fertilizer according to the invention, the glassy-matrix preparations are used in the form of finely ground powders with an average diameter of less than 100 μm and preferably less than 60 μm.

The solubility in water and acids of the glassy-matrix preparations is a function of the formulation of said glassy matrix, by varying which it is possible to adjust and modulate the speed of effect of the glassy-matrix preparation or preparations inserted in the fertilizer and therefore the release times of the trace element or elements added thereby, in relation to the speed of effect of the elemental sulfur.

In a particular but not exclusive embodiment of the fertilizer according to the invention, the glassy-matrix preparations that are used comprise, among the components of said matrix, a phosphorus pentoxide (P₂O₅) and a potassium oxide (K₂O) among the modifiers.

Said glassy matrix, moreover, can comprise at least one additional component such as SiO₂, Al₂O₃, TiO₂, ZrO₂, and at least one additional modifier such as Na₂O, Li₂O, CaO, MgO, BaO.

According to the nomenclature commonly used, the trace elements that are present are expressed as B₂O₃, Fe₂O₃, MnO, ZnO, CuO, Mo₂O₃, and CoO.

Conveniently, the glassy-matrix preparations can have a solubility in water that can vary between 1 and 15% and a solubility in weak acids (citric acid) and strong acids (hydrochloric acid) that can vary between 60 and 100%; with these characteristics, the release of the trace element or elements contained in the glassy-matrix preparations reaches 95% in approximately 45 to 74 days.

By changing the formulation of the glassy matrix of the preparations it is therefore possible to adjust and modulate the release times of the trace elements inserted therein, coordinating them, advancing them or delaying them with respect to the effect times of the elemental sulfur.

A possible method for obtaining a fertilizer based on elemental sulfur according to the invention consists in mixing elemental sulfur, at least one binder suitable to break down in the soil and chosen from the group constituted by clays, bentonite, kaolins or the like or mixtures thereof, the fine powder of at least one glassy-matrix preparation that contains at least one trace element chosen from the group constituted by Fe, B, Zn, Cu, Co, Mn, Mo, and an optional wetting agent such as cationic or anionic surfactants; in subjecting the resulting mixture to a thermal treatment up to temperatures on the order of 120-280° C. in order to melt the sulfur; and in subjecting to dripping and subsequent cooling the resulting fluid in order to form particles of fertilizer.

The thermal treatment to which the mixture is subjected must cause the melting of the elemental sulfur and must allow to achieve a sufficient fluidity of the mixture.

In a possible but not exclusive embodiment, the mixture used comprises:

Elemental sulfur 65-95% by weight

Binder 3-25% by weight

Glassy-matrix preparations 3-30% by weight

Wetting agent 0-5% by weight

The percentage of glassy-matrix preparations preferably varies between 6 and 20% by weight.

It is noted that during this procedure the glassy-matrix preparations introduced in the mixture do not melt and are not subjected to chemical attack on the part of the molten sulfur, allowing to maintain unchanged the agronomic properties of the trace elements contained therein: they in fact derive from a forming process at temperatures above 1000° C. and therefore considerably higher than the temperatures used to obtain the fertilizer, with respect to which they remain inert.

Dripping can occur, for example, by means of a plate provided with a plurality of calibrated holes, while cooling can occur by making the drops fall into a liquid, obtaining spheroidal particles, or onto a cooled metallic belt, obtaining lenticular particles.

As an alternative, the fertilizer according to the invention can be obtained with so-called “cold” processes, which consist in extruding or granulating a moist mixture that comprises elemental sulfur, at least one binder suitable to break down in the soil and chosen from the group constituted by clays, bentonites, kaolins or the like or mixtures thereof, at least one glassy-matrix preparation, which comprises at least one trace element selected from the group consisting of Fe, B, Zn, Cu, Co, Mn, Mo and at least one fluid vehicle for obtaining particles.

The mixture can receive the addition of a wetting agent such as cationic or anionic surfactants.

The resulting particles are then subjected to drying.

The fertilizer according to the invention allows to add to the soil, in addition to the elemental sulfur and the trace elements contained in the glassy-matrix preparation o preparations, also other fundamental nutrients, such as phosphorus, potassium and calcium, which are part of said glassy matrix.

The fertilizer particles distributed in the soil swell due to the absorption of moisture on the part of the binder (bentonite, clays, kaolins or the like), which breaks down, releasing the molten elemental sulfur and the particles of the glassy-matrix preparation or preparations.

As already described, processes for oxidation of the sulfur and solubilization of the glassy matrix that contains the trace elements are thus triggered.

The solubilization times of the glassy matrix depend, as mentioned above, on its composition, by modifying which it is therefore possible to adjust and modulate the speed of effect of glassy-matrix preparations with respect to the speed of effect of elemental sulfur in order to achieve an intended synergy of their nutritional contributions.

It is also noted that said synergy is also due to the fact that the elemental sulfur shifts the pH of the soil toward weakly acid values, thus facilitating the attack of the glassy-matrix preparations on the part of the microorganisms of the soil, making available even in relatively short times the trace elements contained therein.

The tight binding of the elemental sulfur and of the glassy-matrix preparations containing trace elements allows to achieve a uniform application and effect of the fertilizer on the entire soil on which it is spread; this is a result that cannot be achieved by their mechanical mixing or by means of individual successive applications of each of said components.

In practice it has been found that the described invention achieves the intended aim.

The fertilizer according to the invention in fact can be obtained with processes that are simple to industrialize, allows to combine and modulate the effects of elemental sulfur with the effects of trace elements, keeping unchanged the agronomic properties of both, and withstands wash-out events.

The disclosures in Italian Patent Application No. MO2002A000251 from which this application claims priority are incorporated herein by reference.

What is claimed is:

1. A fertilizer based on elemental sulfur, comprising elemental sulfur, at least one binder suitable to break down in the soil, and at least one glassy-matrix preparation that contains at least one trace element.

2. The fertilizer according to claim 1, wherein said glassy-matrix preparation is in powder form.

3. The fertilizer according to claim 2, wherein said powder has an average diameter of less than 100 μm.

4. The fertilizer according to claim 1, comprising elemental sulfur in a quantity from 65 to 95% by weight, at least one binder in a quantity from 3 to 25% by weight, and at least one glassy-matrix preparation, containing at least one trace element, in a quantity from 3 to 30% by weight.

5. The fertilizer according to claim 1, further comprising at least one wetting agent.

6. The fertilizer according to claim 5, wherein said wetting agent is present in a quantity smaller than, or equal to, 5% by weight.

7. The fertilizer according to claim 1, wherein said at least one trace element is selected from the group consisting of Fe, B, Zn, Cu, Co, Mn, Mo.

8. The fertilizer according to claim 1, wherein said binder is selected from the group consisting of clays, bentonite, kaolins or the like or mixtures thereof.

9. The fertilizer according to claim 5, wherein said wetting agent is of the type of cationic or anionic surfactants.

10. The fertilizer according to claim 1, wherein said glassy matrix comprises at least one component selected from the group consisting of P₂O₅, SiO₂, Al₂O₃, TiO₂, ZrO₂.

11. The fertilizer according to claim 1, wherein said glassy matrix comprises at least one modifier selected from the group consisting of K₂O, Na₂O, Li₂O, CaO, MgO, BaO.

12. A method for obtaining a fertilizer based on elemental sulfur, comprising the steps of mixing elemental sulfur, at least one binder suitable to break down in the soil and selected from the group consisting of clays, bentonite, kaolins or the like or mixtures thereof, and at least one glassy-matrix preparation that comprises at least one trace element selected from the group consisting of Fe, B, Zn, Cu, Co, Mn, Mo, a thermal treatment of the resulting mixture until the sulfur melts, dripping and cooling of the resulting fluid into particles.

13. The method according to claim 12, further comprising addition of at least one wetting agent, such as cationic or anionic surfactants.

14. The method according to claim 12, wherein said elemental sulfur is mixed in a quantity from 65 to 95% by weight, said binder is mixed in a quantity from 3 to 25% by weight, said glassy-matrix preparation is mixed in a quantity from 3 to 30% by weight, and said wetting agent is mixed in a quantity from 0 to 5% by weight.

15. The method according to claim 12, wherein said thermal treatment is carried out at a temperature from 120 to 280° C.

16. A method for obtaining a fertilizer based on elemental sulfur, comprising extrusion of a wet mixture that comprises elemental sulfur, at least one binder that is suitable to break down in the soil and selected from the group consisting of clays, bentonite, kaolins or the like or mixtures thereof, at least one glassy-matrix preparation comprising at least one trace element selected from the group consisting of Fe, B, Zn, Cu, Co, Mn, Mo, and at least one fluid vehicle, in order to obtain particles, and drying said particles.

17. A method for obtaining a fertilizer based on elemental sulfur, comprising granulation of a moist mixture that comprises elemental sulfur, at least one binder that is suitable to break down in the soil and is selected from the group consisting of clays, bentonite, kaolins or the like or mixtures thereof, at least one glassy-matrix preparation which comprises at least one trace element selected from the group consisting of Fe, B, Zn, Cu, Co, Mn, Mo, and at least one fluid vehicle in order to obtain particles, and drying said particles.

18. The method according to claim 16, further comprising adding to said mixture at least one wetting agent such as cationic or anionic surfactants.
